(19) United States
(12) Patent Application Publication
(10) Pub. No.: US 2017/0153571 A1
(43) Pub. Date: Jun. 1, 2017

(54) IMAGE FORMING APPARATUS

(71) Applicant: Oki Data Corporation, Tokyo (JP)

(72) Inventors: Yuichi FURUKAWA, Tokyo (JP); Hayato MATSUMOTO, Tokyo (JP)

(21) Appl. No.: 15/355,473

(22) Filed: Nov. 18, 2016

(30) Foreign Application Priority Data
Nov. 27, 2015 (JP) 2015-231360

(51) Int. Cl. G03G 9/00

(52) U.S. Cl. CPC G03G 15/0824

(57) ABSTRACT

An image forming apparatus includes a developer; an image carrier on which a latent image is formed; a charge member that charges the image carrier; an exposure part that forms a latent image on the image carrier charged; a developer carrier that carries the developer and develops the latent image on the image carrier as a developer image; and a transfer part that transfers the developer image from the image carrier to a recording medium. The developer is a one-component based developer that is produced by a pulverization method and does not contain a charge adjuvant, and 0.25 (parts by weight) or more of a sol-gel silica to 100 (parts by weight) of a base particle as an external additive is added.

### CROSS REFERENCE TO RELATED APPLICATION

This application claims priority under 35 USC 119 to Japanese Patent Application No. 2015-231360 filed on Nov. 27, 2015 original document, the entire contents which are incorporated herein by reference.

### TECHNICAL FIELD

The present invention relates to an image forming apparatus, such as, e.g., a photocopier, a printer, and a FAX, using an electrographic system, and especially relates to an image forming apparatus using a specific developer.

### BACKGROUND

Conventionally, in an image forming apparatus using an electrographic system, some image forming apparatuses employ an intermediate transfer method to attain high image quality and multi-media support, in which after all toners are once transferred from an image forming unit to an intermediate transfer member, transferring to a recording medium, such as a paper, is collectively performed (for example, see Patent Document 1).

### RELATED ART

[Patent Doc. 1] Japanese Laid-Open Patent Publication 2012-150174, see page 8, FIG. 1

For example, in cases where an intermediate transfer method is employed, as compared to a direct transfer method in which transferring is performed directly on a recording medium, such as, e.g., a paper, the demand for the transferability of toners is high since two transfer steps are needed. On the other hand, for a developer, a pulverized toner is sometimes used from the viewpoint of high-speed, multi-media support, and cost. This derives from the improved fixability and the ease of adding a charge control agent of a polyester resin having high affinity to paper. However, a pulverized toner generally has a disadvantage that the shape is uneven and therefore it is harder to improve the transfer performance in comparison to a polymerized toner having a spherical or quasi-spherical shape. Particularly in the intermediate transfer method, in a print pattern such as a thin line, there is a problem of ununiformity in the transfer step called thin-line blurring that a central part of a line is not sufficiently transferred, causing a white spot.

### SUMMARY

An image forming apparatus includes a developer; an image carrier on which a latent image is formed: a charge member that charges the image carrier: an exposure part that forms a latent image on the image carrier charged; a developer carrier that carries the developer and develops the latent image on the image carrier as a developer image; and a transfer part that transfers the developer image from the image carrier to a recording medium. The developer is a one-component based developer that is produced by a pulverization method and does not contain a charge adjuvant, and 0.25 (parts by weight) or more of a sol-gel silica to 100 (parts by weight) of a base particle as an external additive is added.

An image forming apparatus includes a developer; an image carrier on which a latent image is formed; a charge member that charges the image carrier; an exposed part that forms a latent image on the charged image carrier; a developer carrier that carries the developer and develops the latent image of the image carrier as a developer image; a transfer part that transfers the developer image from the image carrier to a recording medium; and a fuser that fuses the developer image to the recording medium. The developer is produced by a pulverization method, in a measurement result of the developer by a differential scanning calorimetry, when a same sample of the developer is melted twice continuously, an endothermic peak between 0° C. and 70° C. exists at a time of first melting, and no endothermic peak between 0° C. and 70° C. exists at a time of second melting after cooling, a roundness of the developer is 0.955 or more and 0.970 or less, and a particle size of the developer is 5.5 μm or more and 6.5 μm or less.

According to the present invention, in printing using a pulverized toner, even when printing is performed by an intermediate transfer method, printing with a high print grade can be executed.

### BRIEF DESCRIPTION OF THE DRAWINGS

FIG. 1 is a main part configuration view showing a configuration of a main part of a printer as an image forming apparatus according to Embodiment 1 of the present invention.

FIG. 2 is a main part configuration view showing a configuration of a main part of an image forming unit.

FIG. 3 is a block diagram mainly showing a main configuration of a control system of a printer according to the present invention.

FIG. 4 is a drawing for explaining an operation of a secondary transfer step.

FIG. 5 is a drawing for explaining a case when the secondary transfer is performed unevenly.

FIG. 6 is a drawing for explaining print patterns in each transfer evaluation test (1).

FIG. 7 is a main part configuration view showing a configuration of a main part of a printer as an image forming apparatus according to Embodiment 2 of the present invention.

FIG. 8 is a drawing for explaining a print pattern in a fusing evaluation test.

### DETAILED DESCRIPTION OF THE EMBODIMENTS

### Embodiment 1

FIG. 1 illustrates a main part configuration showing a configuration of a main part of a printer 1 as an image forming apparatus according to Embodiment 1 of the present invention.

The printer 1 is provided with a configuration as a color electrophotographic printer using an intermediate transfer method capable of printing four colors: yellow (Y), magenta (M), cyan (C), and black (K). As shown in the drawing, a sheet feeding cassette 15 accommodates recording sheets 71 as recording mediums arranged therein in a stacked manner, and a hopping roller 16 takes out the recording sheet 71 one by one from the sheet feeding cassette 15 and sends them sequentially to a carrying path. On the downstream side of the hopping roller 16 in the arrow A direction showing the carrying direction of the recording sheet 71, a pair of registration rollers 17 configured to correct the skew of the recording sheet 71 is provided so as to send the recording sheet 71 to a secondary transfer part 47 at a predetermined timing.

A development forming part 66 is provided with four image forming units 61Y, 61M, 61C, 61K (hereinafter simply referred to as 61 when there is no need to distinguish among them), each configured to form a toner image of each of the colors, yellow (Y), magenta (M), cyan (C), and black (K), and four LED heads 67Y to 67K (hereinafter simply referred to as 67 when there is no need to distinguish among them). The four image forming units 61Y to 61K are arranged in that order from the upstream side along the arrow B direction showing the moving direction of a later-explained intermediate transfer belt 44 of an intermediate transfer belt unit 40 which moves on the upper part of the intermediate transfer belt unit 40, and the four LED heads 67Y to 67K, as will be described later, are arranged facing the respective image forming units 61Y to 61K to irradiate light on a predetermined part of a photosensitive drum 3 provided to each image forming unit 61. It should be noted that yellow (Y), magenta (M), cyan (C), and black (K) may be sometimes simply referred to as (Y), (M), (C), and (K).

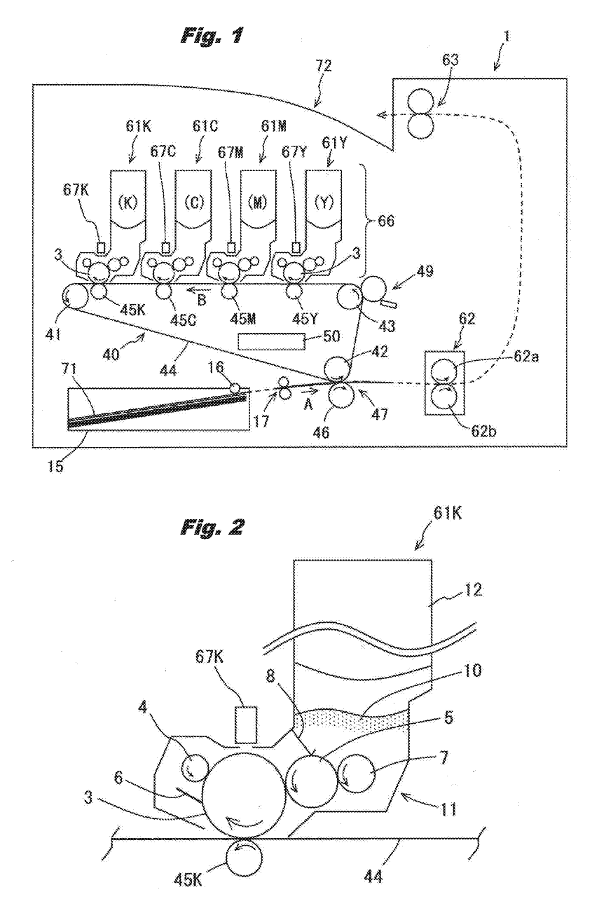

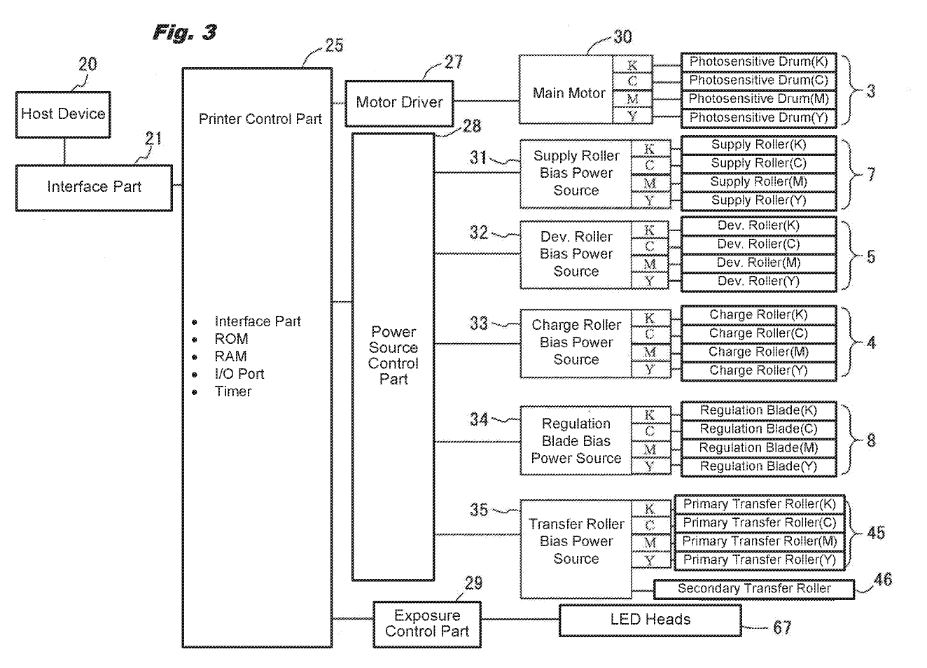

Since these image forming units 61 have a common internal configuration, the common internal configuration will be explained by exemplifying the black (K) image forming unit 61K. FIG. 2 is a main part configuration view showing the configuration of the main part of the image forming unit 61K.

As shown in the figure, the image forming unit 61 is constituted by a development device 11 and a toner cartridge 12. The development device 11 is constituted by a photosensitive drum 3 as an image carrier, a charge roller 4 as a charge member configured to charge the photosensitive drum 3, a development roller 5 as a rotatable developer carrier arranged facing the photosensitive drum 3, a supply roller 7 configured to supply a toner 10 on the development roller 5 and collect the unused toner on the development roller 5, a regulation blade 8 configured to form the toner on the development roller 5 in a thin layer, and a cleaning blade 6 configured to collect the transfer residual toner on the photosensitive drum 3.

In the vicinity of the cleaning blade 6, there is a space for accommodating the waste toner scraped off by the cleaning blade 6, and the waste toner is carried to an unillustrated waste toner collection container. A toner cartridge 12 is attached to the development device 11 with the purpose of supplying the toner 10.

The photosensitive drum 3, the development roller 5, the supply roller 7, and the charge roller 4 each rotate in the arrow direction shown in FIG. 2. The photosensitive drum 3 is driven by a main motor 30 (FIG. 3), which will be described later, and the drive is transmitted to the development roller 5 from the photosensitive drum 3 by unillustrated gears, and in the same manner, the drive is transmitted to the supply roller 7 from the development roller 5 by an unillustrated idler gear to rotate the supply roller 7. The charge roller 4 co-rotates by being in contact with the photosensitive drum 3.

The LED head 67 as an exposure part is provided with, for example, an LED element and a lens array, and is arranged at a position so that irradiation light output from the LED element forms an image on the surface of the photosensitive drum 3.

The intermediate transfer belt unit 40 is equipped with a drive roller 41 driven by a main motor 30 (FIG. 3), which will be described later, a tension roller 43 configured to apply a tension to the intermediate transfer belt 44, a secondary transfer backup roller 42 arranged facing the secondary transfer roller 46 via the intermediate transfer belt 44 and constituting a secondary transfer part 47, and the intermediate transfer belt 44 stretched over these rollers.

Further, the intermediate transfer belt unit 40 is arranged facing the photosensitive drums 3 of the image forming units 61Y to 61K via the intermediate transfer belt 44, and equipped with four primary transfer rollers 45Y to 45K (hereinafter simply referred to as “45” when there is no need to distinguish among them), etc., each for applying a predetermined voltage for primarily transferring each toner image formed on each photosensitive drum 3 onto the intermediate transfer belt 44. The intermediate transfer belt unit 40 and the secondary transfer roller 46 correspond to a transfer part.

The intermediate transfer belt unit 40, as described above, primarily transfers a toner image formed by the development forming part 66 to the intermediate transfer belt 44 and further carries the primarily transferred toner image to the secondary transfer part 47. At the secondary transfer part 47, the toner image transferred to the intermediate transfer belt 44 is secondarily transferred by the secondary transfer roller 46 to the recording sheet 71 supplied from the sheet feeding cassette 15.

The toner that was not transferred at the secondary transfer part 47 and remained on the intermediate transfer belt 44 is cleaned by a transfer belt cleaning member 49 and passes an unillustrated path to be collected by a waste toner collection part 50. The intermediate transfer belt 44 is driven by a main motor 30 (FIG. 3) and each of the primary transfer rollers 45 is co-rotated by being in contact with the intermediate transfer belt 44.

A fuser device 62 includes an upper roller 62a for heating which is rotatably driven in the arrow direction by an unillustrated drive source and a lower roller 62b for applying a pressure which is driven by being in press-contact with the upper roller 62a. A nip part of the fuser device nips and carries the recording sheet 71 sent from the secondary transfer part 47, and in the carrying process, and melts the toner image by applying heat and pressure to the toner image on the recording sheet 71 to melt the toner image to fuse the melted toner image on the recording sheet 71. An ejection roller pair 63 ejects the printed recording sheet 71 sent out from the fuser device 62 to a face-down stacker 72.

The configuration of each of the members used here will be further described.

The photosensitive drum 3 is constituted by, for example, a conductive support and a photo-conductive layer, and is an organic photoreceptor having a configuration in which a charge generation layer and a charge transportation layer as photo-conductive layers are sequentially laminated on an aluminum metallic pipe as a conductive support.

For the development roller 5, a development roller in which a semiconductive urethane rubber is formed on a conductive shaft is used. To obtain conductivity of an elastic layer, an electronic conductive agent or an ionic conductive agent, such as, e.g., a carbon black and a conductive filler, is dispersed as a conductive agent. The outer diameter is 19.6 mm, the measured value of hardness using Asker C (manufactured by Asker (Kobunshi Keiki Co., Ltd.)) is 77°, and the partial resistance is 20 MΩ. The partial resistance value recited here denotes an average value of measurement values at six locations when measured by arranging ball bearings each having an outer diameter of 6 mm and a width of 1.5 mm in equal pitches at six locations in the longitudinal direction of the development roller 5 in a state in which the bearings are pressed against the surface of the development roller 5 by applying a pressure of 20.0 [gf] and a direct current voltage of −100 [V] is applied between the ball bearings and the conductive shaft.

For the supply roller 7, a supply roller in which a semiconductive foamed silicone rubber is formed on a conductive shaft is used. The outer diameter is set to 15.6 mm by grinding, and the measured value of the hardness using Asker F (manufactured by Asker (Kobunshi Keiki Co., Ltd.)) is 57°, and the partial resistance is 30 MΩ. The silicon rubber compound is constituted by adding a reinforcing silica filter, a vulcanization agent needed for vulcanization hardening, and a foaming agent to various synthetic rubbers, such as, e.g., a dimethyl silicon rubber and a methyl phenyl silicon rubber.

The regulation blade 8 is constituted by SUS (stainless steel) having a thickness of 0.08 mm, which is subjected to a bent process at the contact part with the development roller 5, and the curvature radius R of the bent part is 0.5 mm and the roughness is Rz=0.6 μm in ten-point average roughness.

The conductive elastic layer of the charge roller 4 is an ionic conductive rubber elastic layer in which an epichlorohydrin rubber (ECO) is the main component. The surface of the elastic layer is subjected to a surface treatment for curing by impregnating in a surface treatment solution including an isocyanate (HDI) to prevent contamination of the surface of the contacting photosensitive drum 3 and to obtain release properties of a toner and its external additives, etc.

In the toner 10, external additives, such as, e.g., inorganic fine powders and organic fine powders (hereinafter referred to as “external additives”) are added to toner base particles containing at least a binder resin.

As the binder resin, although not especially limited, it is preferable to use a polyester based resin, a styrene-acrylic based resin, an epoxy based resin, or a styrene-butadiene based resin. In the binder resin, a release agent, a coloring agent, etc., are added, and other additives, such as, e.g., a charge control agent, a conductive adjuster, a fluidity improver, and a cleaning improver, may be arbitrarily added. Further, the binder resin may be a mixture of plural types of resins. In this embodiment, a polyester resin having a crystal structure is used besides a plurality of amorphous polyester based resins, and 5 (parts by weight) of a polyester resin is added to 100 (parts by weight) of a binder resin.

In the present invention, a pulverization method is used for producing the base particles. A pulverization method denotes a method for producing a toner base particle having a predetermined particle size by: melt-kneading a material other than external additives, such as, e.g., a binder resin, a release agent, and a charge control agent, in advance using an extruder, a biaxial kneading device, etc., to obtain an ingot of the toner base particles; cooling the ingot; thereafter coarsely grinding the ingot with a cutter mill, etc.; then crushing it using a collision pulverization device; and further classifying it using an air-classifier, etc. In the invention, any types of pulverization methods that were available when the invention was made are useful to embody the invention. Also, it does not intend to exclude any future methods to pulverize particles, which are to be developed later.

As the release agent, although not especially limited, any well-known release agents may be exemplified. Examples of well-known release agents include a low molecular weight polyethylene, a low molecular weight polypropylene, an olefin copolymer, a microcrystalline wax, a paraffin wax, an aliphatic hydrocarbon based wax, such as a Fischer-Tropsch wax, oxides of an aliphatic hydrocarbon based wax, such as, e.g., a polyethylene oxide wax or their block copolymers, a carnauba wax, waxes containing an aliphatic ester, such as, e.g., a montan acid ester wax as a main component, a release agent in which a part or all of aliphatic esters, such as. e.g., a deoxidation carnauba wax are deoxidized. For the content rate of the release agent, 0.1 (parts by weight) to 20 (parts by weight) of a release agent is added to 100 (parts by weight) of a binder resin. It is preferable to add 0.5 (parts by weight) to 12 (parts by weight), which is effective. Further, it is preferable to use a plurality of waxes together.

As the coloring agent, although not especially limited, a single or a plural types of conventional dyes, pigments, etc., used as toner coloring agents for black, yellow, magenta, and cyan may be used. For example, a carbon black, an iron oxide, a phthalocyanine blue, a permanent brown FG, a brilliant fast scarlet, a pigment green B, a Rhodamine B base, a solvent red 49, a solvent red 146, a pigment blue 15:3, a solvent blue 35, a quinacridone, a carmine 6B, a disazo yellow, etc., can be exemplified. For the content rate of the coloring agent, 2 (parts by weight) to 25 (parts by weight), preferably 2 (parts by weight) to 15 (parts by weight), is added to 100 (parts by weight) of the binder resin.

As the charge control agent, any known charge control agents can be used. For example, in the case of a negatively charged toner, an azo based complex charge control agent, a salicylate based complex charge control agent, a calixarene based charge control agent, etc., can be exemplified. The content rate of the charge control agent is 0.05 (parts by weight) to 15 (parts by weight), preferably 0.1 (parts by weight) to 10 (parts by weight), to 100 (parts by weight) of the binder resin.

The external additive is added to improve the environmental stability, charging stability, developability, fluidity, and preservability, and any known external additives may be used. The content rate of the external additive is 0.01 (parts by weight) to 10 (parts by weight), preferably 0.05 (parts by weight) to 8 (parts by weight), to 100 (parts by weight) of a binder resin.

In this embodiment, as an external additive, 3.0 (parts by weight) of a hydrophobic silica R972 (manufactured by Japan Aerosil corporation; mean diameter: 16 (nm)) and 0.3 (parts by weight) of melamine resin particles Eposter S (manufactured by Nippon Shokubai Co., Ltd., mean diameter: 0.2 (μm)) was added to 1 kg of a base particle (100 (parts by weight)) and mixed using a Henschel mixer to adhere to the toner base particle. Thus, an external additive A toner was created for cyan, magenta, yellow, and black. In addition to the external additive of the external additive A, using a sol-gel silica (manufactured by Shin-Etsu Chemical Co., Ltd.; mean particle diameter: 50 nm to 200 nm, bulk density: 0.40 g/cm³ to 0.50 g/cm³; hydrophobicity: 50% to 80%), four types of external additives, in which the added amount was changed and added, were created for cyan, magenta, yellow, and black. Thus, an external additive B (sol-gel silica: 0.1 parts by weight) toner, an external additive C (sol-gel silica: 0.25 parts by weight) toner, an external additive D (sol-gel silica: 0.75 parts by weight) toner, and an external additive E (sol-gel silica: 1.5 parts by weight) toner were obtained. These external additives A to E toner were used as samples in a transfer evaluation test (1) which will be described later.

The toners used in this embodiment have the following features. That is, all of the toners are negatively charged and they are common in thermophysical properties since they are common in toner base particle. The TG (glass transition point) is 60.8° C. in differential scanning calorimetric measurement by a differential scanning calorimeter (EXSTAR 600 manufactured by SII (Seiko Instruments Inc.). A weak endothermic peak is observed between 0° C. to 70° C. at the time of first melting (first time). The peak is not observed when melting again (second time) after first melting and then cooling.

FIG. 3 is a block diagram mostly showing a main configuration of a control system of the printer 1 according to the present invention.

In the figure, a printer control part 25 is constituted by a microprocessor, a ROM, a RAM, an input/output port (I/O Port), a timer, etc., and receives print data and a control command from a host device 20 to sequentially control the whole printer 1 to perform a printing operation. An interface part 21 transmits printer information to the host device and analyzes a command input from the host device 20 as well, and processes the data received from the host device 20 and send the data to the printer control part 25.

A motor driver 27 drivingly controls the main motor 30 for rotatably driving the photosensitive drum 3 based on instructions from the printer control part 25, so that the rotation of the photosensitive drum 3 is transmitted to the development roller 5 and the supply roller 7 by a gear transmission mechanism, etc., and as shown in FIG. 2, each of the parts is rotated at predetermined speeds in the arrow directions as shown in the figure accompanying the rotation of the photosensitive drum 3 in the arrow direction at a predetermined speed. The main motor 30 also rotatably drives the drive roller 41 of the intermediate transfer belt unit 40 at the same time.

A power source control part 28 sets and changes each bias voltage based on the instruction of the printer control part 25. A supply roller bias power source 31 applies a DC constant voltage to each of the supply rollers 7 (Y), (M), (C), and (K). A development roller bias power source 32 applies a DC constant voltage to each of the development rollers 5 (Y), (M), (C), and (K). A charge roller bias power source 33 applies a DC constant voltage to each of the charge rollers 4 (Y), (M), (C), and (K). A regulation blade bias power source 34 applies a DC constant voltage to each of the regulation blades 8 (Y), (M), (C), and (K). A transfer roller bias power source 35 applies a DC constant voltage to each of the primary transfer rollers 45 and the secondary transfer rollers 46 of (Y), (M), (C), and (K). Each of the voltage values is controlled by the power source control part 28.

An exposure control part 29 performs, based on print data, a control for forming an electrostatic latent image by irradiating light by each of the LED heads 67 (Y), (M), (C), and (K) (FIG. 1) on the surface of each of the charged photosensitive drums 3 facing the LED heads.

Further, the printer control part 25 also performs image processing, a medium carrying control and a fusing control besides what is described above, but these explanations will be omitted.

In the aforementioned configuration, the print processing operation of the printer 1 will be explained with reference to FIGS. 1 to 3. The dotted arrow shown in FIG. 1 shows the carrying direction of the carried recording sheet 71.

In each image forming unit 61, the surface of each photosensitive drum 3 is uniformly charged to −500 V by the charge roller 4 to which a voltage of −1,000V is applied from the charge roller bias power source 33. Next, the LED head 67, based on image data, selectively irradiates light and exposes the charged surface of the photosensitive drum 3 which rotates in the arrow direction, and forms an electrostatic latent image on the surface with the exposed part set as −50 V.

On the other hand, a voltage of −300 V is applied to the supply roller 7 from the supply roller bias power source 31 and the toner 10 is supplied on the development roller 5. The toner on the development roller 5 is charged to around −25 μC/g from the friction, etc., against the regulation blade 8, and made into a thin layer, and further, adheres to the electrostatic latent image from the potential difference between the development roller 5 to which a voltage of −200V is applied by the development roller bias power source 32 and the electrostatic latent image on the photosensitive drum 3 and develops the electrostatic latent image. The undeveloped toner 10 on the development roller 5 is scraped off by the supply roller 7. With this, a toner image is formed on the surface of the photosensitive drum 3.

The toner image formed on each photosensitive drum 3 is primarily transferred on the intermediate transfer belt 44 by the primary transfer roller 45 to which a voltage of +1,500 V is applied by the transfer roller bias power source 35 when passing the transfer position in contact with the intermediate transfer belt 44. At this time, the toner image forming timing to each photosensitive drum 3 is set so that the toner image of each color transferred on the intermediate transfer belt 44 is sequentially and repeatedly transferred on the intermediate transfer belt 44. At this stage, a color image is formed by each of superimposed toner images of yellow (Y), magenta (M), cyan (C) and black (K) colors.

On the other hand, in parallel to the above-described color image formation on the intermediate transfer belt 44, a recording sheet 71 set in the sheet feeding cassette 15 is taken out from the sheet feeding cassette 15 by the hopping roller 16, and carried to the secondary transfer part 47 with its skew corrected by a pair of registration rollers 17. At the secondary transfer part 47, when the recording sheet 71 passes between the secondary transfer roller 46 and the secondary transfer backup roller 42 which are in contact with each other via the intermediate transfer belt 44, the color image on the intermediate transfer belt 44 is secondarily transferred to a predetermined position on the recording sheet 71 by the secondary transfer roller 46 to which a voltage of +2,000 V is applied by the transfer roller bias power source 35.

Next, the recording sheet 71 in which a color image by toner images of each color was transferred on the surface thereof is carried to the fuser device 62 by an unillustrated carrying means. The toner image on the recording sheet 71 melts by being heated while pressure is applied by the fuser device 62, and fuses to the recording sheet 71. The recording sheet 71 to which the toner image was fused is ejected to the face-down stacker 72 on the exterior of the device by a pair of ejection rollers 63, and the print process operation is completed. During this time, the intermediate transfer belt 44 after separation of the recording sheet 71 is cleaned by the transfer belt cleaning member 49 for removing a toner and other foreign bodies remaining on the belt.

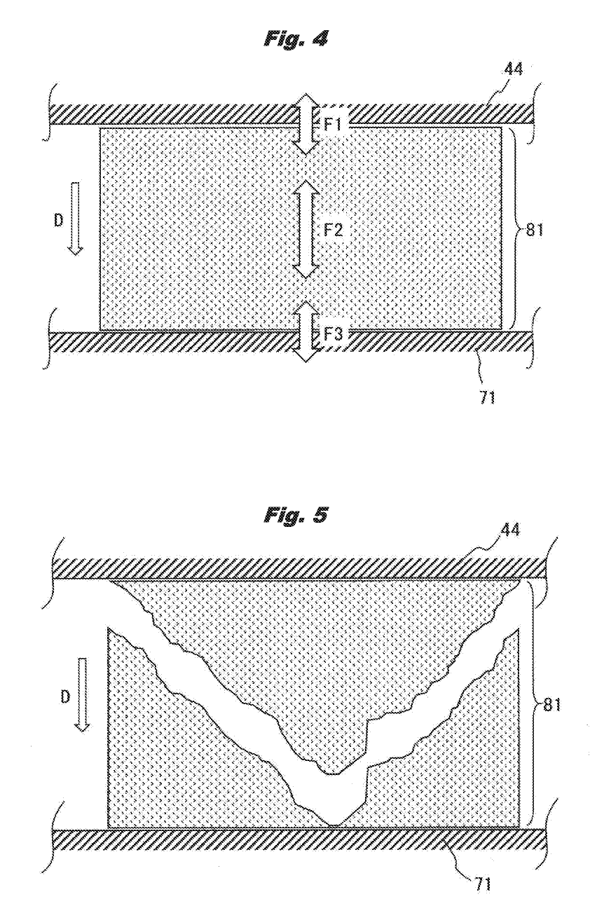

The operations of the transfer step in the series of print operations will be further explained. In the two transfer steps of the primary transfer step and the secondary transfer step, the toner moves from the balance between the electrostatic force and the physical adhering force. FIG. 4 is a drawing for explaining an operation of the secondary transfer step. FIG. 5 is a drawing for explaining a case when the secondary transfer is performed unevenly.

As shown in FIG. 4, at the time of the secondary transfer, an adhesive force F1 is exerted between the intermediate transfer belt 44 and the toner layer (toner image) 81, an adhesive force F2 is exerted between the toners of the toner layers 81, and an adhesive force F3 is exerted between the toner layer 81 and the recording sheet 71 as a recording medium. These forces are a resultant force of the Coulomb force, the adhesive force of the toner surfaces, the Van der Waals force, etc., and under the conditions in which the transfer voltage is applied, for the charged toner, the Coulomb force is exerted in the transfer direction as shown by the arrow D of the drawing. Therefore, the adhesive force F1 is mainly dominated by the adhering force of the toner, and the adhesive force F2 and the adhesive force F3 are dominated by the adhering force and the Coulomb force.

Generally, an excellent transfer can be realized when the relationship of the following formula is satisfied:

F1<F2 and F1<F3.

When the adhesive force F1 is large or the adhesive forces F2 and F3 are small, the transfer becomes uneven as shown in FIG. 5, so that the portion of the toner layer 81 that was not transferred appears as a thin-line blur in the printing. In particular, in a toner produced by a pulverization method, F1, F2, and F3 tend to become uneven since the shapes are uneven, and therefore, thin-line blurring can easily occur.

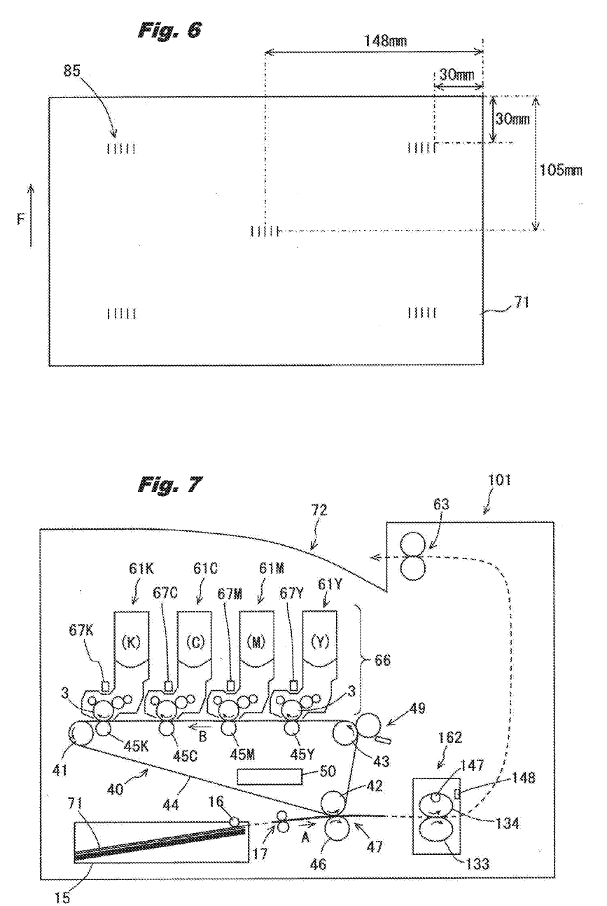

Next, to investigate the issues in printing such as thin-line blurring, etc., a transfer evaluation test (1) for blurring and a transfer evaluation test (2) for blushing performed with five types of toners of the aforementioned external additives A to E toners different in external additive, and arbitrarily added toners as samples, will be explained. FIG. 6 is a drawing for explaining print patterns in each transfer evaluation test (1).

The transfer evaluation test (1) for blurring was performed under the following testing conditions.

(1) In the test, a test device basically having the same configuration as the printer 1 as shown in FIG. 1 was used, and the voltage value applied to each part by the power source control part 28 was also set to the same value as the printer 1.

(2) As shown in FIG. 6, in a layout in which a print pattern 85 in which five thin lines each having a width of 0.3 mm and a length of 10.0 mm and arranged at 5 mm intervals were arranged at the four corners and the central part of the recording sheet 71 with the measurements shown in the drawing, printing was performed horizontally on five excellent white sheets (80 g/m², A4 size) in the print direction as shown by the arrow F in FIG. 6 and under a temperature of 25° C. and a humidity of 50%.

(3) In the five recording sheets on which the print pattern 85 was printed, the presence or absence of blurring was observed under an optical microscope for a total of 125 printed thin lines on the sheet surface. The blurring was evaluated in three steps depending on the degree of blurring. “⊚” indicates no occurrence of blurring, “∘” indicates slight occurrence of blurring that could not be seen visually but could be discovered by observation under an optical microscope, and “x” indicates that it could be seen visually.

(4) The transfer evaluation test (1) for blurring was performed for each toner (C), (M), (Y), and (K).

On the other hand, blushing after printing can be exemplified as a side effect of adding a sol-gel silica. The worsening of the blushing arises from the facts that the toner used here is a type of toner in which a one-component based toner using frictional charging which does not use a carrier, etc., as a charge adjuvant is used, and that adding of a sol-gel silica results in a reduced frictional force between the toners generated from the effects of the regulation blade 8, which deteriorates the charge. The blushing denotes a phenomenon in which the reversely charged toner on the development roller 5 electrically moves to the non-exposed part on the photosensitive drum 3 and the toner is printed on a blank paper part.

The transfer evaluation test (1) for blushing ΔE was performed under the following testing conditions.

(5) A horizontal belt pattern of 0.3% duty was printed on A4 recording sheets one by one for every 10 seconds for a total of 2,500 sheets.

(6) After that, for the purpose of extracting the toner adhered to the non-exposed part on the photosensitive drum 3, a mending tape (manufactured by Sumitomo 3M Company) was peeled off after being pasted on the photosensitive drum 3 and then pasted on a blank paper sheet.

(7) On the blank paper sheet, a new mending tape that was not pasted on the photosensitive drum 3 was pasted in advance, and the color difference between the new mending tape and the mending tape pasted on the photosensitive drum 3 was measured by a Spectrophotometer (CM2600d manufactured by Konica Minolta, Inc.).

(8) When the blushing ΔE, which is determined when the external additive A toner with no addition of a sol-gel silica is a sample, is EA, “◯” indicates that the difference between the blushing ΔE and EA was 0.50 or less when the other toners were used as samples, “Δ” indicates that it was more than 0.5 and less than 1.0 (0.5 and 1.0 are not inclusive in the range), and “X” indicates that there was a difference of 1.0 or more. For example, in the comparison with the blushing EB when the external additive B toner is a sample, when

EB−EA≧1.0,

the blushing evaluation of the external additive B toner is evaluated as “X”.

Further, when the difference between the blushing ΔE and EA is 0.50 or less in which the evaluation is “◯”, the blushing phenomenon is suppressed within a permissible range.

(9) The transfer evaluation test (1) for blushing was performed for (C), (M), (Y), and (K) toners.

The test device and the other test conditions, such as, e.g., the set applied voltage for each part, are the same as the aforementioned transfer evaluation test (1) for blurring.

The results and the evaluations of the transfer evaluation test (1) for a cyan (C) toner are shown in Table 1.

TABLE 1
[(Cyan)]

| | Addition Amount | | | |
|---|---|---|---|---|
| External | of Sol-Gel Silica | Thin-Line | | Blushing |
| Additive | [parts/weight] | Bulurring | Blushing [ΔE] | Judgment |
| External | 0.00 | X | 0.68 | — |
| Additive A | | | | |
| External | 0.10 | X | 0.62 | ◯ |
| Additive B | | | | |
| External | 0.25 | ◯ | 0.83 | ◯ |
| Additive C | | | | |
| External | 0.75 | ◯ | 1.07 | ◯ |
| Additive D | | | | |
| External | 1.00 | ⊚ | 1.11 | ◯ |
| Additive F | | | | |
| External | 1.50 | ⊚ | 1.23 | Δ |
| Additive E | | | | |

In the transfer evaluation test (1) for the cyan (C) toner, a toner in which the addition amount of the sol-gel silica is 1.0 (parts by weight) was newly added as an external additive F toner in addition to the external additive A to E toners. As shown in the Table, for the thin-line blurring, the thin-line blurring improves as the addition amount of the sol-gel silica increases, and since the print evaluation of the thin-line blurring becomes “◯” from the external additive C toner, it can be understood that it is sufficient that the addition amount is 0.25 (parts by weight) or more at lowest. Further, since the print evaluation is “⊚” when the addition amount is 1.00 or more, it is more preferable to add 1.00 (parts by weight) or more.

On the other hand, for the blushing ΔE, it deteriorates as the addition amount of the sol-gel silica increases, and for the external additive E toner, since the difference of the blushing between it and the external additive A toner exceeds 0.5, the print evaluation is “Δ”. According to the result, it is preferable that the upper limit of the upper limit of the addition amount be 1.00 (parts by weight).

That is, for the cyan (C) toner, it is preferable to set the addition amount of the sol-gel silica to:

0.25 (parts by weight)≦addition amount≦1.00 (parts by weight).

Next, the results and the evaluations of the transfer evaluation test (1) for a magenta (M) toner are shown in Table 2.

TABLE 2
[(Magenta)]

| | Addition Amount | | | |
|---|---|---|---|---|
| External | of Sol-Gel Silica | Thin-Line | | Blushing |
| Additive | [parts/weight] | Bulurring | Blushing [ΔE] | Judgment |
| External | 0.00 | X | 1.03 | — |
| Additive A | | | | |
| External | 0.10 | X | | |
| Additive B | | | | |
| External | 0.25 | ◯ | 1.01 | ◯ |
| Additive C | | | | |
| External | 0.50 | ◯ | 1.39 | ◯ |
| Additive G | | | | |
| External | 0.75 | ◯ | 1.55 | Δ |
| Additive D | | | | |
| External | 1.50 | ⊚ | 1.73 | Δ |
| Additive E | | | | |

In the transfer evaluation test (1) for the magenta (M) toner, a toner in which the addition amount of the sol-gel silica was 0.5 (parts by weight) was newly added as an external additive G toner in addition to the external additive A to E toners. As shown in the Table, for the thin-line blurring, in the same manner as the cyan (C) toner, the thin-line blurring improves as the addition amount of the sol-gel silica increases, and since the print evaluation of the thin-line blurring becomes “◯” from the external additive C toner, it can be understood that it is sufficient that the addition amount is 0.25 (parts by weight) or more at the lowest. Further, since the print evaluation is “⊚” when the addition amount is 1.50 or more, it is preferable to add 1.50 (parts by weight) or more.

On the other hand, in the same manner as the cyan (C) toner, the blushing ΔE deteriorates as the addition amount of the sol-gel silica increases, and for the external additive D toner, since the difference of the blushing between it and the external additive A toner exceeds 0.5, the print evaluation is “Δ”. From this result, it is preferable that the upper limit of the addition amount be 0.50 (parts by weight). That is, for the magenta (M) toner, it is preferable to set the addition amount of the sol-gel silica to:

0.25 (parts by weight)≧addition amount≧0.50 (parts by weight).

Next, the results and the evaluations of the transfer evaluation test (1) for a yellow (Y) toner are shown in Table 3. [Table 3]

TABLE 3
[(Yellow)]

| | Addition Amount | | | |
|---|---|---|---|---|
| External | of Sol-Gel Silica | Thin-Line | | Blushing |
| Additive | [parts/weight] | Bulurring | Blushing [ΔE] | Judgment |
| External | 0.00 | X | 1.34 | — |
| Additive A | | | | |
| External | 0.10 | X | 1.43 | ◯ |
| Additive B | | | | |
| External | 0.25 | ◯ | 1.63 | ◯ |
| Additive C | | | | |
| External | 0.50 | ◯ | 1.72 | ◯ |
| Additive G | | | | |
| External | 0.76 | ◯ | 2.03 | Δ |
| Additive D | | | | |
| External | 1.50 | ⊚ | 2.54 | X |
| Additive E | | | | |

Also in the transfer evaluation test (1) for the yellow (Y) toner, in the same manner as the magenta (M) toner, a toner in which the addition amount of the sol-gel silica was 0.50 (parts by weight) was newly added as an external additive G toner in addition to the external added A to E toners. As shown in the Table, for thin-line blurring, in the same manner as the cyan (C) toner and the magenta (M) toner, the thin-line blurring improves as the addition amount of the sol-gel silica increases, and since the print evaluation of the thin-line blurring becomes “◯” from the external additive C toner, it can be understood that it is sufficient that the addition amount 0.25 (parts by weight) or more at the lowest. Further, since the print evaluation is “⊚” when the addition amount is 1.50 or more, it is preferable to add 1.50 (parts by weight) or more.

On the other hand, in the same manner as the cyan (C) and magenta toners, the blushing ΔE deteriorates as the addition amount of the sol-gel silica increases, and for the external additive D toner, since the difference of the blushing between it and the external additive A toner exceeds 0.5, the print evaluation is “Δ”. From this result, it is preferable that the upper limit of the addition amount be 0.50 (parts by weight).

That is, for the yellow (Y) toner, it is preferable to set the addition amount of the sol-gel silica to:

0.25 (parts by weight)≦addition amount≦0.50 (parts by weight).

Next, the results and the evaluations of the transfer evaluation test (1) for a black (K) toner are shown in Table 4.

TABLE 4
[(Black)]

| | Addition Amount | | | |
|---|---|---|---|---|
| External | of Sol-Gel Silica | Thin-Line | | Blushing |
| Additive | [parts/weight] | Blurring | Blushing [ΔE] | Judgment |
| External | 0.00 | X | 1.01 | — |
| Additive A | | | | |
| External | 0.10 | X | 1.11 | ◯ |
| Additive B | | | | |
| External | 0.25 | ◯ | 1.25 | ◯ |
| Additive C | | | | |
| External | 0.50 | ◯ | 1.50 | ◯ |
| Additive G | | | | |
| External | 0.75 | ◯ | 1.71 | Δ |
| Additive D | | | | |
| External | 1.50 | ⊚ | 2.50 | X |
| Additive E | | | | |

Also in the transfer evaluation test (1) for the black (B) toner, in the same manner as the magenta (M) and yellow (Y) toners, a toner in which the addition amount of the sol-gel silica was 0.50 (parts by weight) was newly added as an external additive G toner in addition to the external added A to E toners. As shown in the Table, for thin-line blurring, in the same manner as the cyan (C), magenta (M) and yellow (Y) toners, the thin-line blurring improves as the addition amount of the sol-gel silica increases, and since the print evaluation of the thin-line blurring becomes “◯” from the external additive C toner, it can be understood that it is sufficient that the addition amount is 0.25 (parts by weight) or more. Further, since the print evaluation is “⊚” when the addition amount was 1.50 or more, it is preferably to add 1.50 (parts by weight) or more.

On the other hand, in the same manner as the cyan (C), magenta (M) and yellow (Y) toners, the blushing ΔE deteriorates as the addition amount of the sol-gel silica increases, and for the external additive D toner, since the difference of the blushing between it and the external additive A toner exceeds 0.5, the print evaluation is “Δ”. From this result, it is preferable that the upper limit of the addition amount is 0.50 (parts by weight).

That is, for the black (B) toner, it is preferably to set the addition amount of the sol-gel silica to:

0.25 (parts by weight)≦addition amount≦0.50 (parts by weight).

As described above, according to the printer 1 of this embodiment, by setting the addition amount of the sol-gel silica to 100 (parts by weight) of the base particle in the toner to be used to:

0.25 (parts by weight)≦addition amount≦1.00 (parts by weight) for the cyan (C) toner; and

0.25 (parts by weight)≦addition amount≦0.50 (parts by weight) for the magenta (M), yellow (Y), black (B) toners,

occurrence of phenomena, such as, e.g., thin-line blurring and blushing at the time of printing, can be suppressed.

Like the electrophotographic printer of this embodiment, by using toners in which the addition amount of the sol-gel silica contained as an external additive is appropriately set, even in the case of using a toner produced by a pulverization method which is hard to improve the transfer performance and performing printing by an intermediate transfer method which is more strict in transfer condition, occurrence of thin-line blurring and blushing occurring on the print material can be suppressed.

### Embodiment 2

FIG. 7 is a main configuration view showing a main configuration of a printer 101 of an image forming apparatus according to Embodiment 2 of the present invention.

The main difference between this printer 101 and the aforementioned printer 1 of Embodiment 1 shown in FIG. 1 is the configuration of a fuser device 162. Therefore, the same symbols are allotted to the parts of the printer 101 that are the same as the aforementioned printer 102, drawings and explanations will be omitted, and the different points will be mainly explained.

In the fuser device 162 as a fuser, a fuser belt 134 as a belt member that rotates in the arrow direction in the drawing by an unillustrated rotation drive mechanism and a pressure belt 133 as a belt member that co-rotates with the fuser belt 134 are provided, and the fuser device melts the toner image transferred on the recording sheet 71 with heat from a heater 147 provided in the fuser belt 134. The fuser belt 134 and the pressure belt 133 contact with each other in a pressed manner, and sandwich and carry the recording sheet 71 at the contact part, and in the carrying process, apply heat and pressure to the toner image on the recording sheet 71 and melt the toner image to fuse the melted toner image to the recording sheet 71. The ejection roller pair 63 ejects the printed recording sheet 71 sent out from the fuser device 162 to the face-down stacker 72.

The fuser belt 134 and the pressure belt 133 are both constituted by SUS (stainless steel), a silicon rubber, and a resin, and the outer circumference is covered by an endless polyimide belt covered by a fluorine-based resin. Further, a thermistor 148 for fusing is provided so as to face the fuser belt 134, and the heater 147 is selectively turned on based on the surface temperature of the fuser belt 134 detected by the thermistor to control the surface temperature of the fuser belt 134 and maintain a predetermined temperature.

The toner used in this embodiment is produced by a pulverization method, and uses a similar toner base particle as explained for the aforementioned Embodiment 1. Further, using a Hybridization System NHS-1 type (manufactured by Nara Machinery Co., Ltd.), the toner is rounded by being processed at a predetermined rotor speed, time, and temperature. As a result of a measurement using a differential scanning calorimeter (EXSTAR600 manufactured by SII (Seiko Instruments Inc.)), Tg (glass transition point) of the base particle was 60.8° C. and a weak endothermic peak was observed between 0° C. to 70° C. at the time of first melting (first time) and the peak is not observed when melting again (second time) after first melting and then cooling.

The external additive is added to improve the environmental stability, charging stability, developability, fluidity, and preservability, and any known external additives may be used. The content rate of the external additive is 0.01 (parts by weight) to 10 (parts by weight), preferably 0.05 (parts by weight) to 8 (parts by weight), to 100 (parts by weight) of the binder resin.

In this embodiment, as an external additive, 3.0 (parts by weight) of a hydrophobic silica R972 (manufactured by Japan Aerosil corporation; mean diameter: 16 (nm)) and 0.3 (parts by weight) of melamine resin particles EPOSTAR S (manufactured by Nippon Shokubai Co., Ltd., mean diameter: 0.2 (μm)) were added to 1 (kg) of the base particle (100 (parts by weight)) and mixed using a Henschel mixer to adhere to the toner mother article to obtain a toner.

To avoid duplicate explanation, hereinafter, the following explanation will be directed to a magenta (M) toner.

The toner produced under the aforementioned conditions that is the base for this embodiment is referred to as a toner A. Further, toners having the contents listed in Table 5 were also produced for the comparison evaluation performed for the later-explained fusing evaluation test and the transfer evaluation test (2). Furthermore, an item with no particular explanation was made under the same recipe and manufacturing conditions as the toner A.

TABLE 5

| | | | Addition | | |
|---|---|---|---|---|---|
| | | | Amount of | | |
| | | | Crystalline | | |
| | | | Polyester | Particle | |
| | | | [parts/ | Diameter | |
| Product | Purpose | Contents | weight] | [μm] | Roundness |
| Toner A | Mutual | | 5.0 | 6.0 | 0.960 |
| Toner B | Fusing | No | 0.0 | 5.5 | 0.951 |
| | Evaluation | Crystalline | | | |
| | | Polyester | | | |
| | | Added | | | |
| Toner C-1 | Transfer | Roundness | 5.0 | 6.0 | 0.937 |
| Toner C-2 | Evaluation | Adjusting | 5.0 | 6.0 | 0.951 |
| Toner C-3 | | | 5.0 | 6.0 | 0.955 |
| Toner C-4 | | | 5.0 | 6.0 | 0.970 |
| Toner D-1 | | Particle | 5.0 | 5.2 | 0.960 |
| Toner D-2 | | Diameter | 5.0 | 5.5 | 0.960 |
| Toner D-3 | | Adjusting | 5.0 | 6.5 | 0.960 |
| Toner D-4 | | | 5.0 | 6.9 | 0.960 |

As shown in the table,
A crystalline polyester was not added to the toner B. The particle diameter and the roundness differ from the toner A, but it is understood that there is no influence on the fixability, which is the purpose of the evaluation.
The toners C-1 to C-4 were obtained by adjusting the roundness of the toner A. The adjustment was performed by changing the rotor rotation speed, the time, and the temperature in the rounding process. At that time, the toners having a roundness of 0.970 or better could not be stably produced.
The toners D-1 to D-4 were produced by adjusting the particle diameter of the toner A. The adjustment was performed by changing the classification rotor rotation speed of the air-classifier. For the toners D-1 to D-3, the addition amount of the external additive was changed so that the coverage becomes the same as the toner A.

The particle diameter was measured using the Multisizer III manufactured by Beckman Coulter, Inc., and the roundness was measured using FPIA3000 manufactured by Sysmex Corporation.

In the printing operation by the printer 101 having the aforementioned configuration, since the main operation other than the fusing processing of the fuser device 162 is the same as the printing operation as explained for the aforementioned Embodiment 1, the explanation for the common parts will be omitted here.

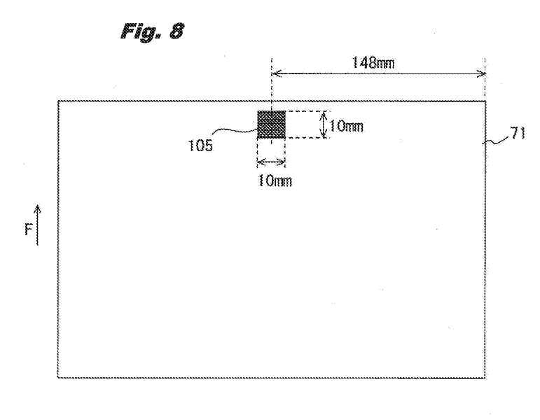

Among these series of operations, the fusing step and the transfer step will be further explained. FIG. 8 is a drawing for explaining the print pattern in a later-explained fusing evaluation test.

In the fusing step, when the amount of heat provided to the toner (image) transferred on the recording sheet 71 from the fuser belt 134 as a heating member is insufficient, a printing failure (hereinafter may sometimes be referred to as “unfused”) that the toner peels off from the recording sheet 71 may occur. This is likely to occur when printing is performed on a sheet having a low softening point in which the fusing temperature needs to be set at a low temperature and a thick paper which can easily absorb the heat of the fuser device 162.

Now, the fusing evaluation test performed using the printer 101, a toner A, and a toner B will be explained.

(10) In the test, a test device basically having the same configuration as the printer 101 as shown in FIG. 7 was used, and the voltage value applied to each part by the power source control part 28 was also set to the same value as the printer 101.

(11) Under the environment in which the temperature was 25° C. and the humidity was 50%, and using an excellent white sheet as a recording sheet (80 g/m², A4 size, manufactured by OKI Data Corporation), the print speed was set to 202 mm/sec and the fusing temperature was set in 5° increments from 120° C. to 160° C.

(12) As shown in FIG. 8, on a recording sheet 71 to be printed horizontally with respect to the printing direction (arrow F direction), for a print area 105 of a rectangular shape (10 mm×10 mm) provided approximately in the central part at the front end part (excluding the unprintable area) in the printing direction having the measurement shown in the drawing, 100% solid printing was performed using the toner A and toner B.

(13) At this time, the solid density was measured using an x-rite spectrodensitometer (manufactured by X-Rite Inc.). After that, a tape (a mending tape manufactured by Sumitomo 3M Company) was pasted on the print part (print area 105) and a 500 g weight was reciprocated once on top of it. Thereafter, the tape was peeled. At this time, no force was applied on top other than the self-weight of the weight, and the moving speed of the weight was 10 mm/sec.

(14) The density of the tape peeled part was measured in the same manner, and the fixing ratio was calculated from the following formula:

Fixing ratio (%)=100×density after peeling the tape/density of the printed part after solid printing.

(15) For the evaluation of the fixing ratio,
When the fixing ratio was less than 90%, the fusion was not performed, which is denoted as “x”, and
When the fixing ratio was 90% or better, the fusion was good, which is denoted as “∘”.

The results and the evaluations of the fusing evaluation test are shown in Table 6.

TABLE 6

| | | Fusing Temp. | | | | | | | | |
|---|---|---|---|---|---|---|---|---|---|---|
| Product | Contents | 120 | 125 | 130 | 135 | 140 | 145 | 150 | 155 | 160 |
| Toner A | Base Toner | X | X | ◯ | ◯ | ◯ | ◯ | ◯ | ◯ | ◯ |
| Toner B | No Crystaline | X | X | X | X | X | X | ◯ | ◯ | ◯ |
| | Polyester Added | | | | | | | | | |

As it is apparent from the evaluation of Table 6, as with the toner A of this embodiment, the low temperature fixability is improved by 20° C. as an effect of adding a crystalline polyester as a binder resin. In Table 6, X means poor, ◯ means good or fine.

On the other hand, in the two transfer steps, the primary transfer and the secondary transfer among the series of printing operations, the toner moves due to the balance between the electrostatic force and the physical adhering force. For example, since the transfer operation and the principle of occurrence of thin-line blurring in the secondary transfer step were explained using FIG. 4 and FIG. 5 in the aforementioned Embodiment 1, the explanation herein will be omitted.

To examine the printing issues, such as, e.g., thin-line blurring, the transfer evaluation test (2) performed using the toner A, the toner C-1 to the toner C-4, and the toner D-1 to the toner D-4 shown in Table 5 as samples will be explained. The transfer evaluation test (2) for blurring in this embodiment was performed under the same test conditions (1) to (3) as the transfer evaluation test (1) for blurring of the aforementioned Embodiment 1.

For the test, the same type of test device having basically the same configuration as the printer 101 shown in FIG. 7 was used.

On the other hand, when the toner is made to have a larger particle diameter, there is a side effect that blushing worsens. This is because the surface area per unit volume decreases when the toner is made to have a large particle diameter. Since the toner is charged mainly on the surface and the toner amount (volume) used for the development does not largely change even when the particle diameter is changed, the decrease in the surface area per unit volume becomes the cause of low charging as it is.

The transfer evaluation test (2) of blushing ΔE was performed under the following test conditions.

(16) A 0% duty pattern was printed on one sheet of A4 recording sheet.

(17) For the purpose of collecting the toner adhered to the non-exposed part on the photosensitive drum 3, a mending tape was pasted on the photosensitive drum 3 and then peeled off therefrom, and thereafter pasted on a blank paper sheet.

(18) On the blank paper sheet, a new mending tape not pasted on the photosensitive drum 3 was pasted in advance, and the color difference between the new mending tape and the mending tape pasted on the photosensitive drum 3 was measured by a Spectrophotometer (CM2600d manufactured by Konica Minolta, Inc.).

(19) When blushing ΔE of the toner A is EA, when other toners were used as the sample, for the difference between the blushing ΔE and EA, “⊚” indicates that the difference was 0.50 or less, “◯” indicates that a difference was more than 0.5 and less than 1.0 (0.5 and 1.0 are not inclusive in the range), and “x” indicates that a difference was 1.0 or more. For example, in a comparison with the toner B, when

EB−EA≧1.0,

the blushing evaluation of the toner B was denoted as “x”.

In addition, in the case of “⊚” evaluation that the difference between the blushing ΔE and EA was within 0.50, the blushing phenomenon was suppressed within a permissible range.

The test device and the other test conditions, such as, e.g., the set applied voltage for each part, were the same as the aforementioned transfer evaluation test (2) for blurring.

The results and the evaluations of the transfer evaluation test (2) for thin-line blurring in the toner C-1 to the toner C-4 and the toner A in which the roundness was adjusted is shown in Table 7.

TABLE 7

| | | Particle Diameter | | Thin-Line |
|---|---|---|---|---|
| Product | Content | [μm] | Roundness | Blurring |
| Toner C-1 | Roundness | 6.0 | 0.937 | X |
| Toner C-2 | Adjusting | 6.0 | 0.951 | ◯ |
| Toner C-3 | | 6.0 | 0.955 | ⊚ |
| Toner A | Base Toner | 6.0 | 0.960 | ⊚ |
| Toner C-4 | Roundness | 6.0 | 0.970 | ⊚ |
| | Adjusting | | | |

As it is apparent from the table, the thin-line blurring improves as the roundness increases, and specifically, it can be understood that it is sufficient that the roundness is 0.955 or greater. On the other hand, since it is difficult to stably produce a base material having a roundness of 0.970 or more as described above, it can be understood that excellent printing can be realized with no thin-line blurring with a toner having a roundness:

0.955≦roundness≦0.97.

Next, the results and the evaluations of the transfer evaluation test (2) for thin-line blurring and blushing in the toner D-1 to the toner D-4 and the toner A that the particle diameter was adjusted are shown in Table 8.

TABLE 8

| | | Particle | | Thin- | | Comp. |
|---|---|---|---|---|---|---|
| | | Diameter | Round- | Line | Blushing | Judge- |
| Product | Contents | [μm] | ness | Blurring | [Δ E] | ment |
| Toner D-1 | Particle | 6.2 | 0.960 | ◯ | ⊚ | X |
| Toner D-2 | Diameter | 5.5 | 0.960 | ⊚ | ⊚ | ◯ |
| | Adjusting | | | | | |
| Toner A | Base Toner | 6.0 | 0.960 | ⊚ | ⊚ | ◯ |
| Toner D-3 | Particle | 6.5 | 0.960 | ⊚ | ⊚ | ◯ |
| Toner D-4 | Diameter | 6.0 | 0.960 | ⊚ | ◯ | X |
| | Adjusting | | | | | |

In the table, the comprehensive judgment was denoted as “◯” when excellent printing was obtained when both evaluation results of thin-line blurring and blushing were “⊚”, and denoted as “X” when either one was “X” or “◯” since there was a printing failure.

As it is apparent from the table, it can be understood that the thin-line blurring improves as the particle diameter increases and that excellent printing can be obtained when it is 5.5 μm or larger. On the other hand, it can be understood that blushing worsens as the particle diameter increases and that excellent printing cannot be obtained unless it is 6.5 μm or less.

That is, with a toner having a toner particle diameter satisfying the following formula, excellent printing with no side effects of thin-line blurring and blushing can be realized:

5.5 μm≦toner particle diameter≦6.5 μm.

As described above, according to the printer 101 of this embodiment, by setting the roundness of the toner used to

0.955≦roundness≦0.970

and the particle diameter to

5.5 μm≦toner particle diameter≦6.5 μm,

and further using a pulverized toner including a crystalline polyester as a binder resin, occurrences of phenomena, such as, e.g., thin-line blurring, blushing, and poor fusing at the time of printing, can be suppressed.

In the above, the magenta (M) toner was explained, but the results were similar for the other toners, yellow (Y), cyan (C), and black (B).

Generally, as a characteristic of a pulverized toner, for a toner in which a weak endothermic peak is observed between 0° C. to 70° C. when melting for the first time (first time) and the peak is not observed when it is melted again (second time) after first melting and then cooling it, the fixability is excellent but it is an disadvantageous characteristic for transferring, and therefore thin-line blurring and blushing can easily occur.

Even in the case of using such a toner, as described above, by using a toner in which the particle diameter and the roundness are appropriately set, as with the color electrophotographic printer of this embodiment, even in the case of printing with an intermediate transfer part belt method, the phenomena, such as, e.g., thin-line blurring and blushing occurring on a print medium, can be suppressed. Further, in an upper and lower belt direct heat fusing method (a heat member and a pressure member are belt-shaped), occurrences of fusing failure can be suppressed by using a pulverized toner including a crystalline polyester.

In the aforementioned embodiment, an example in which the present invention of this application was applied to a color printer using an electrographic system is exemplified, but it is not limited to that, and can be applied to a monochromatic printer, an MFP (Multi Function Printer), a facsimile, a label making device, a photocopier, etc.

What is claimed is:

1. An image forming apparatus, comprising:
a developer;
an image carrier on which a latent image is formed;
a charge member that charges the image carrier;
an exposure part that forms a latent image on the image carrier charged;
a developer carrier that carries the developer and develops the latent image on the image carrier as a developer image; and
a transfer part that transfers the developer image from the image carrier to a recording medium, wherein
the developer is a one-component based developer that is produced by a pulverization method and does not contain a charge adjuvant, and
0.25 (parts by weight) or more of a sol-gel silica to 100 (parts by weight) of a base particle as an external additive is added.

2. The image forming apparatus according to claim 1, wherein
the sol-gel silica added to the developer is 1.00 (parts by weight) or less in a case of a cyan toner, and
the sol-gel silica added to the developer is 0.50 (parts by weight) or more in a case of each of magenta, yellow and black toners.

3. The image forming apparatus according to claim 1, wherein
the transfer part primarily transfers the developer image from the developer carrier to a belt-shaped intermediate transfer member, and further secondarily transfers it from the intermediate transfer member to the recording medium.

4. The image forming apparatus according to claim 1, wherein
in a measurement result of the developer by a differential scanning calorimetry, when a same sample of the developer is melted twice continuously, an endothermic peak between 0° C. and 70° C. exists at a time of first melting, and no endothermic peak between 0° C. and 70° C. exists at a time of second melting after cooling.

5. The image forming apparatus according to claim 1, wherein
a mean particle diameter of the sol-gel silica is 50 nm to 200 nm, a bulk density of the sol-gel silica is 0.4 g/cm³ to 0.5 g/cm³, and a hydrophobicity of the sol-gel silica is 50% to 80%.

6. The image forming apparatus according to claim 1, wherein
the developer is a negatively charged toner.

7. An image forming apparatus, comprising:
a developer;
an image carrier on which a latent image is formed;
a charge member that charges the image carrier;
an exposed part that forms a latent image on the charged image carrier;
a developer carrier that carries the developer and develops the latent image of the image carrier as a developer image;
a transfer part that transfers the developer image from the image carrier to a recording medium; and
a fuser that fuses the developer image to the recording medium, wherein
the developer is produced by a pulverization method,
in a measurement result of the developer by a differential scanning calorimetry, when a same sample of the developer is melted twice continuously, an endothermic peak between 0° C. and 70° C. exists at a time of first melting, and no endothermic peak between 0° C. and 70° C. exists at a time of second melting after cooling,
a roundness of the developer is 0.955 or more and 0.970 or less, and
a mean particle size of the developer is 5.5 μm or more and 6.5 μm or less.

8. The image forming apparatus according to claim 7, wherein
the transfer part primarily transfers the developer image from the developer carrier to a belt-shaped intermediate transfer member and further secondarily transfers it from the intermediate transfer member to the recording medium.

9. The image forming apparatus according to claim 7, wherein
the fuser includes a pair of belt-shaped members that sandwiches and carries the recording medium and applies heat and pressure in a carrying process, wherein
the developer includes a crystal polyester.
